(19) United States
(12) Patent Application Publication
(10) Pub. No.: US 2025/0237783 A1
(43) Pub. Date: Jul. 24, 2025

(54) Light Curtain

(71) Applicant: Leuze electronic GmbH + Co. KG, Owen/Teck (DE)

(72) Inventors: Sebastian Olbrich, München (DE); Stanislav Sudiyan, München (DE); Bernhard Feller, Friedberg (DE)

(21) Appl. No.: 19/021,278

(22) Filed: Jan. 15, 2025

(30) Foreign Application Priority Data
Jan. 22, 2024 (DE) 202024100304.7

(51) Int. Cl. G01V 8/20

(52) U.S. Cl. CPC G01V 8/20

(57) ABSTRACT

A light curtain (1) for capturing objects in a monitoring region, with an arrangement of transmitters (4) emitting light beams (3), with an arrangement of receivers (6, 6′) receiving light beams (3), and with an evaluation unit (8) in which an object identification signal is generated in dependence upon receipt signals from the receivers (6, 6′). The receivers (6, 6′) constitute at least one cascade and are individually switched sequentially into an amplifier (12, 12′) via a multiplexer (11, 11′), wherein the amplifier (12, 12′) is deactivated during an activation of a switching-in of a receiver (6).

### CROSS REFERENCE TO RELATED APPLICATIONS

This application claims the priority of DE 202024100304.7 filed on 2024 Jan. 22; this application is incorporated by reference herein in its entirety.

### BACKGROUND

The invention relates to a light curtain.

Such a light curtain is previously known from DE 10 2008 050 943 A1, for example. The light curtain is for monitoring objects within a monitoring region. In particular, the light curtain is formed as a safety light curtain which is used for monitoring hazard regions within the scope of safety technology. The light curtain comprises an arrangement of transmitters that are housed in the housing of a transmitter unit. Furthermore, an arrangement of receivers is provided, which are housed in a housing of a receiver unit. The transmitter and receiver units are arranged at opposite edges of the monitoring region. In the case of a free monitoring region, the light beams emitted by a transmitter are guided to an associated receiver. The transmitter and the associated receiver form a beam axis. For object detection, the receipt signals of the receivers are evaluated in the evaluation unit and a binary switching signal is generated in dependence thereupon as an object identification signal, the switching states of which indicate whether an object is located in the monitoring region or not. An object intervention takes place when at least one beam axis is interrupted by an object.

The operation of the light curtain proceeds such that the beam axes, i.e. the transmitters and receivers of the individual beam axes, are individually activated sequentially, cyclically. In the light curtain described in DE 10 2008 050 943 A1, the individual transmitters are activated individually using shift registers. The receivers are also activated individually using shift registers. The synchronization of the transmitter and receiver activation is done in an optical manner. For this purpose, the light beams of a selected beam axis are used.

To increase the detection sensitivity of the light curtain, the receipt signals are amplified before being fed to the evaluation unit.

In this context, it is known to operate one or a plurality of amplifiers in a multiplex operation such that a plurality of receivers are sequentially switched into the respective amplifier, such that their receipt signals are amplified in the amplifier.

The advantage here is that a separate amplifier does not have to be used for each receiver, such that it is only necessary to provide a few components on the receiving side.

One disadvantage of such arrangements is that switching processes with which another receiver is switched into the amplifier in each case, carried out with a multiplexer, result in transient oscillation events in the amplified receipt signals, i.e. the amplified receipt signals are distorted. For this reason, a waiting period until the transient oscillation events have subsided is necessary after each switching event. However, this results in an undesired increase in the object detection response time of the light curtain.

### SUMMARY

The invention relates to a light curtain (1) for capturing objects in a monitoring region, with an arrangement of transmitters (4) emitting light beams (3), with an arrangement of receivers (6, 6′) receiving light beams (3), and with an evaluation unit (8) in which an object identification signal is generated in dependence upon receipt signals from the receivers (6, 6′). The receivers (6, 6′) constitute at least one cascade and are individually switched sequentially into an amplifier (12, 12′) by means of a multiplexer (11, 11′), wherein the amplifier (12, 12′) is deactivated during an activation of a switching-in of a receiver (6).

### DETAILED DESCRIPTION

The invention seeks to solve the problem of providing a light curtain of the type mentioned at the outset which has a simple design structure and with which a reliable object detection can be carried out with short response times.

The features of the independent claims are provided to solve this problem. Advantageous embodiments and useful further developments of the invention are described in the dependent claims.

The invention relates to a light curtain for capturing objects in a monitoring region, with an arrangement of light beam-emitting transmitters, with an arrangement of light beam-receiving receivers, and with an evaluation unit in which an object identification signal is generated in dependence upon receipt signals from the receivers. The receivers constitute at least one cascade. The receivers are individually switched into an amplifier sequentially by means of a multiplexer, wherein the amplifier is deactivated during activation of a switching-in of a receiver.

According to a first variant, the light curtain has an arrangement of transmitters, which advantageously are integrated in a housing of a transmitter unit. Furthermore, the light curtain advantageously has a receiver unit integrated into a further housing, in which an arrangement of receivers are arranged. The transmitter unit and the receiver unit are arranged at opposite edges of the monitoring region. A receiver is assigned to each transmitter for forming a beam axis such that when the monitoring region is free, the light beams of a transmitter are guided unhindered to the assigned receiver of the respective beam axis. An object in the monitoring region is recognized in that at least the light beams of one beam axis are interrupted.

According to a second variant, both transmitters and receivers are present in the first as well as in the second housing as sensor components.

In particular, an alternating series arrangement of transmitters and receivers is present in each housing.

In this case as well, the transmitters and receivers are arranged such that when the monitoring region is free, the light beams of each transmitter pass through the monitoring region unhindered and hit an assigned receiver. In this case as well, an object in the monitoring region is recognized in that at least the light beams of one beam axis are interrupted.

In general, an object identification signal is generated with the light curtain upon capture of an object.

According to a first variant, the object identification signal is a binary switching signal, the switching states of which indicate whether an object is present in the monitoring region or not.

According to a second variant, the object identification signal contains a geometric characteristic value of a captured object.

The geometric characteristic value can be the object size or object contour of an object.

According to an advantageous embodiment, the light curtain is a safety sensor. The light curtain then has a failsafe design and can thus be used in safety-related applications. In particular, the failsafe design can also be realized by a multichannel evaluation unit.

On the receiving side, the light curtain according to the invention has at least one amplifier, operated in multiplex operation, with which chronologically sequential receipt signals from different receivers are amplified. For this purpose, a multiplexer is associated with each amplifier on the receiving side.

Since it is not necessary for an amplifier to be associated with each receiver, but rather the or each amplifier performs the amplification of receipt signals from a plurality of receivers, a significant savings of components results, which reduces the design effort of the light curtain.

In the simplest case, the light curtain according to the invention only has one cascade with receivers, wherein thereto only a multiplexer and an amplifier are assigned.

Furthermore, with the light curtain according to the invention, a plurality of cascades of receivers can be present, wherein the receivers of each cascade are switched into an amplifier by means of a multiplexer.

In each case, with a multiplexer, the receivers of the respective cascade are individually switched sequentially into the respective amplifier.

According to the invention, this amplifier is deactivated when a switching-in of a receiver to the amplifier is activated.

Especially advantageously, the amplifier is also deactivated when a switching-in of a receiver is deactivated.

Thus, in a simple manner it is ensured that switching processes of the multiplexer that serve for switching-on individual receivers to the associated amplifiers do not or do not significantly influence or, respectively, impair the receipt signals amplified in the amplifier.

Since the amplifier is deactivated during an activation and advantageously also during the deactivation of the switching-in of a receiver to the receiver performed by means of a multiplexer, this amplifier remains uninfluenced by these switching processes. The amplifier is only activated when these switching processes are over.

Thus, in a simple manner it is ensured that the receipt signals amplified in the amplifier are not impaired by switching interference, wherein a reliable and error-free object detection is guaranteed.

Another advantage consists in a very short reaction time during the generation of the object identification signal. Since the or, respectively, each amplifier is deactivated during switching processes of the associated multiplexer, switching interference caused by the multiplexer is not transmitted to the amplifier. As such, wait times in the amplification of the receipt signals that would otherwise be necessary for allowing switching interference present in the received signal to subside are not necessary.

According to an advantageous embodiment, a cascade control is present in the light curtain, by means of which the or all multiplexers are controlled.

The cascade control can be constituted by a controller, for example.

Since the cascade control centrally controls all multiplexers and thus the timing behavior of the activation of all receivers, the timing of the receiver activation can be optimized and monitored optimally in a simple manner.

Especially advantageously, the cascade control is a component of a computer assembly that contains the evaluation unit.

The computer assembly thus has a compact, efficient design, since the evaluation unit is directly associated with the cascade controller.

In the simplest case, the evaluation unit has one single channel and advantageously consists of only one CPU.

Advantageously, the evaluation unit consists of two CPUs which mutually monitor each other. The evaluation unit thus has a redundant, multichannel structure, such that the light curtain can form a safety sensor.

According to advantageous embodiments, each multiplexer has a shift chain or addressing unit.

The addressing unit generally has addresses for addressing the receivers and amplifiers. The shift chain has a series arrangement of shift register elements, wherein advantageously, for its addressing within the shift chain, a receiver or amplifier is respectively associated with a shift register element.

The addressing unit can be realized in a computer unit. The shift chain can consist of a series arrangement of flipflops, wherein the flipflops constitute the shift register elements of the shift chain.

Advantageously, the activation and deactivation of receivers and/or amplifiers is derived from the shift chain or the addressing unit.

Alternatively, the activation and deactivation of receivers and/or amplifiers is performed by means of the cascade control.

The functionality of the multiplexers can be expanded further in that display means can be activated by means of the shift chain or by means of the addressing unit.

The addresses of the addressing unit or shift register elements of the shift chain are then expanded such that with these as well display means can be addressed and thus activated.

The display means can be constituted by light-emitting diodes or alphanumeric displays on which status messages or similar are displayed, in particular also place-resolved for the individual cascades.

According to another advantageous embodiment, the associated amplifier is tested by means of the shift chain or by means of the addressing unit.

In particular, test pulses are generated for testing in the shift chain or in the addressing unit, supplied to the amplifier and read back by the amplifier. Read-back test pulses are compared with an expected result in the shift chain or in the addressing unit.

Target values that correspond to an error-free state can be preset as expected result. If the read-back test pulses differ from the target values, an error message can be generated. Alternatively, a safety function can be triggered. In particular, the light curtain can be placed in standstill.

In the event that the light curtain has a plurality of cascades of receivers, an amplifier addressing unit actuated by the associated multiplexer is associated with each amplifier.

The amplifiers of the individual cascades are selected by the amplifier addressing units.

According to an advantageous further development, the amplifier addressing units can also be used for testing the amplifiers of the individual cascades.

Especially advantageously, every amplifier addressing unit is actuated by the cascade control for activating or deactivating of the associated amplifier.

Then the timing of the activations of the individual [noun] can be centrally specified and monitored via the cascade control.

### BRIEF DESCRIPTION OF THE DRAWINGS

The invention is explained in the following with regard to the drawings. They show:

FIG. 1: Schematic depiction of a first exemplary embodiment of the light curtain according to the invention.

FIG. 2: Schematic depiction of a second exemplary embodiment of the light curtain according to the invention.

FIG. 3: First example of a receiving-side switching arrangement for the light curtain according to FIG. 1.

FIG. 4: Association of an evaluation unit with the cascade control according to FIG. 3.

FIG. 5: Time diagrams for the switching arrangement according to FIG. 3.

FIG. 6: Second example of a receiving-side switching arrangement for the light curtain according to FIG. 1.

FIG. 7: Third example of a receiving-side switching arrangement for the light curtain according to FIG. 1.

### DETAILED DESCRIPTION OF THE PREFERRED EMBODIMENTS

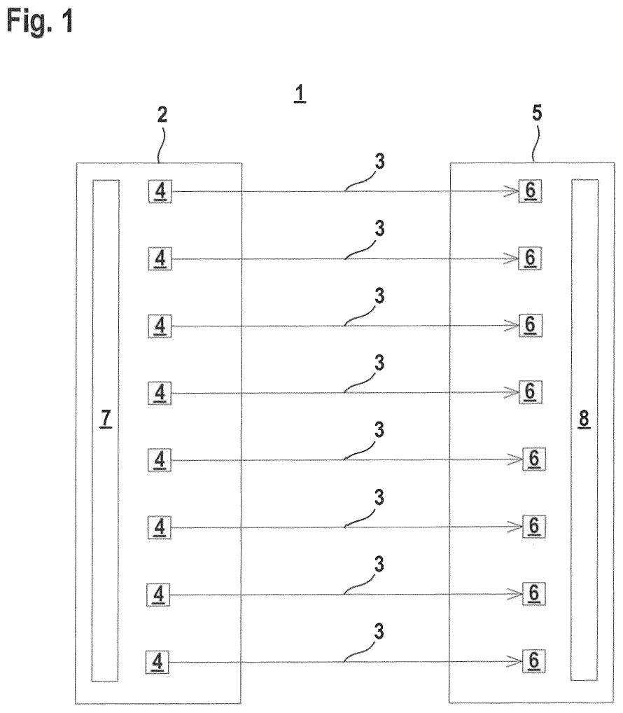

FIG. 1 schematically depicts a first example of the light curtain 1 according to the invention. The light curtain 1 comprises a transmitter unit 2, in the housing of which a series arrangement of transmitters 4 emitting light beams 3 is arranged in the form of transmitting diodes. The transmitting diodes are light-emitting diodes or similar. Furthermore, the light curtain 1 has a receiver unit 5 in the housing of which a series arrangement of receivers 6 receiving light beams 3 is provided in the form of receiving diodes. The receiving diodes are photo PIN diodes or photo diodes. Alternatively, photo transistors can be used.

The transmitter unit 2 and the receiver unit 5 are arranged at opposite edges of a monitoring region. When the monitoring region is free, the light beams 3 emitted respectively by a transmitter 4 hit an associated, opposite-lying receiver 6. A transmitter 4 and the receiver 6 associated therewith respectively constitute a beam axis. The transmitter operation is controlled and evaluated by a control unit 7 in the transmitter unit 2. The receiver operation is controlled through an evaluation unit 8 in the receiving unit 5. The transmitters 4 and receivers 6 of the individual beam axes are activated cyclically through an optical synchronization of the light curtain 1 individually or a plurality at a time sequentially. A protection field running in a plane is monitored with the parallel-running light beams 3 of the beam axes.

For this purpose, the receipt signals from the receiving diodes are evaluated in the evaluation unit 8 to produce a binary switching signal as an object identification signal. The first switching state corresponds to an object message, the second switching state corresponds to a free protection field. Alternatively, a geometric characteristic value of an object, e.g. an object size or object contour, can be output as an object identification signal.

The light curtain 1 forms a safety sensor for use in the field of safety technology. For this purpose, the light curtain 1 has a failsafe design. In particular, the evaluation unit 8 has a multichannel, redundant design, for example in the form of two computer units which monitor each other cyclically.

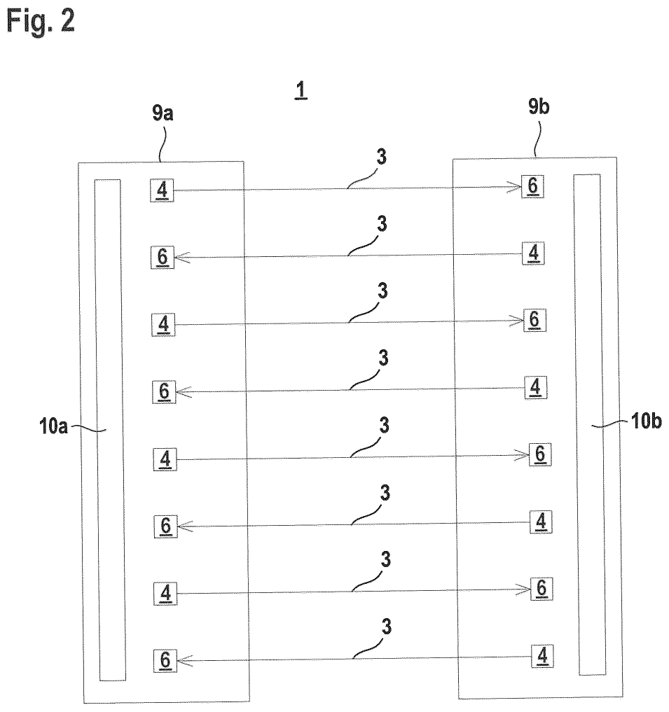

FIG. 2 shows a second exemplary embodiment of the light curtain 1 according to the invention. In this case, the light curtain 1 has two transmitter-receiver units 9a, 9b that are respectively integrated into a housing. In each transmitter-receiver unit 9a, 9b, there is a series arrangement with transmitters 4 and receivers 6, wherein in the present case an alternating arrangement of respectively transmitters 4 and receivers 6 is present. In each transmitter-receiver unit 9a, 9b, there is a control and evaluation unit 10, 10b, by means of which the transmitters 4 present there are controlled and receipt signals from the receivers 6 present there are evaluated. Otherwise, the light curtain 1 according to FIG. 2 corresponds to the light curtain 1 according to FIG. 1.

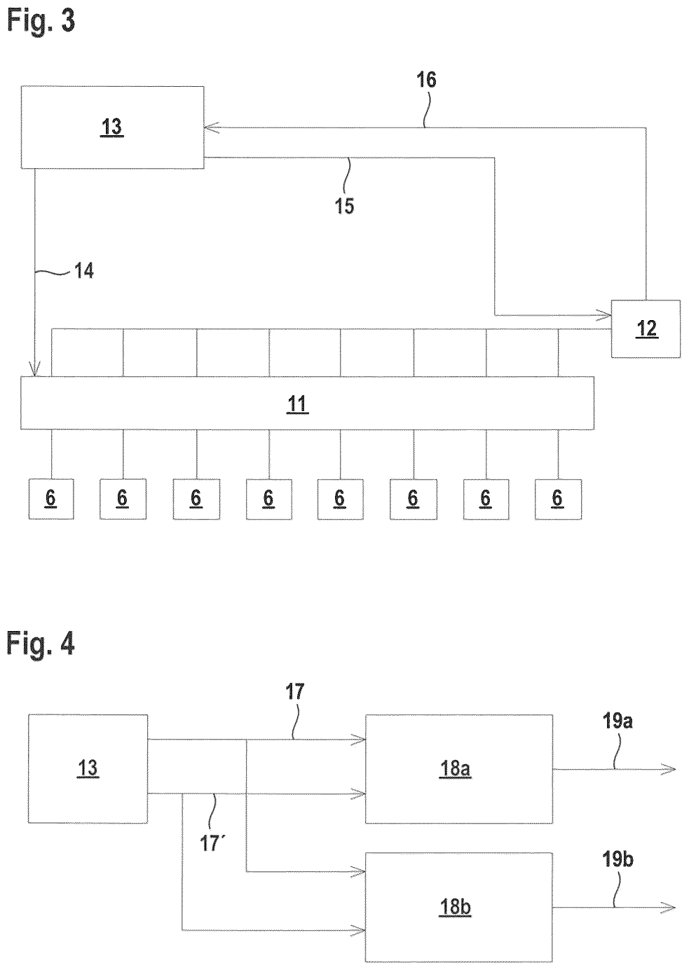

FIG. 3 shows a receiving-side switching arrangement for the light curtain 1 according to FIG. 1. A largely corresponding switching arrangement is also provided for the light curtain 1 according to FIG. 2.

The switching arrangement according to FIG. 3 comprises a multiplexer 11, to which an amplifier 12, which in particular forms a pre-amplifier, is connected.

In the present case, the receivers 6 of the light curtain 1 form a cascade. Accordingly, all receivers 6 are connected to the multiplexer 11.

Furthermore, a cascade control 13 is present, which is formed by a controller or similar. A first control line 4 is run from the cascade control 13 to the multiplexer 11. Control signals from the cascade control 13 are sent to the multiplexer 11 via the control line 14. Furthermore, a second control line 15 is run from the cascade control 13 to the amplifier 12. Control signals are sent to the amplifier 12 from the cascade control 13 via the second control line 15.

A line 16 runs from the amplifier 12 to the cascade control 13. Receipt signals from the receivers 6, amplified by the amplifiers 12, 12′, are sent to the cascade control 13 via the line 16.

According to advantageous embodiments, each multiplexer 11, 11′ has a shift chain or an addressing unit.

The addressing unit generally has addresses for addressing the receivers 6 and amplifiers 12. The shift chain has a series arrangement of shift register elements, wherein advantageously, respectively one receiver 6 or amplifier is associated with a shift register element for its addressing within the shift chain.

The addressing unit can be realized in a computer unit. The shift chain can consist of a series arrangement of flipflops, wherein the flipflops constitute the shift register elements of the shift chain.

Through the control signal of the cascade control 13, which is supplied to the multiplexer 11 via the control line 14, the receivers 6 are cyclically activated sequentially and switched-in to the amplifier 12, where the receipt signals from the receiver 6 are amplified. In principle, receivers 6 can also be activated directly via the multiplexer 11.

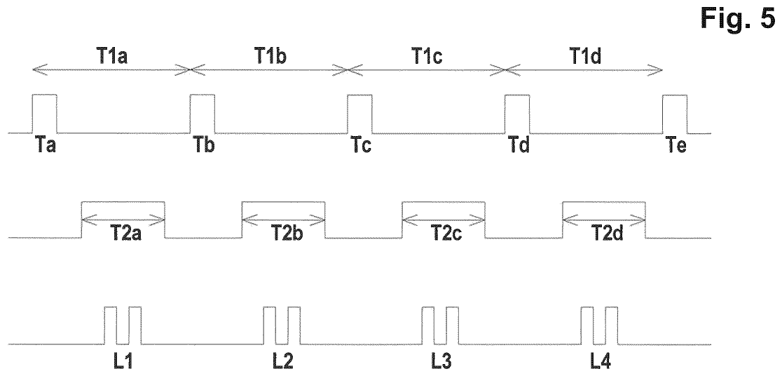

The amplified receipt signals are supplied to the evaluation unit 8 by the cascade control 13. FIG. 4 shows an example of this that applies to all exemplary embodiments of FIGS. 3, 5, 6.

The amplified receipt signals are supplied from the cascade control 13 via lines 17, 17′ in two channels to two CPUs 18a, 18b, which form the evaluation unit 8. Dependent upon the amplified receipt signals, the object identification signal is generated in the CPUs 18a, 18b, which signal is output via a dual channel output design formed by outputs 19a, 19b of the CPUs 18a, 18b.

The functionality of the multiplexer 11 can be expanded further in that display means are activated by means of the shift chain or by means of the addressing unit.

The addresses of the addressing unit or shift register element of the shift chain are then expanded such that with them, display means can also be addressed and thus activated.

The display means can be formed by light-emitting diodes or alphanumeric displays.

According to another advantageous embodiment, the associated amplifier 12 is tested by means of the shift chain or by means of the addressing unit.

In particular, test pulses are generated for testing in the shift chain or in the addressing unit, supplied to the amplifier 12 and read back by it. Read-back test pulses are compared with an expected result in the shift chain or in the addressing unit.

Target values that correspond to an error-free state can be preset as expected results. If the read-back test pulses differ from the target values, an error message can be generated. Alternatively, a safety function can be triggered. In particular, the light curtain 1 can be set to standstill.

FIG. 5 shows time diagrams for the activation according to the invention of receivers 6 and of the amplifier 12 of the switching arrangement according to FIG. 3. In the interest of clarity, in this context time diagrams are only shown for four receivers 6.

The upper time diagram of FIG. 5 shows the activation intervals T1a, T1b, T1c, T2d within which respectively only one of the receivers 6 is activated.

The multiplexer 11 generates a switching pulse Ta, Tb, Tc, Td for activating a receiver 6.

According to the invention, the amplifier 12 is deactivated during the switching processes. For this purpose, the amplifier 12 is only activated during the activation intervals T2a, T2b, T2c, T2d which are outside the switching pulses Ta, Tb, Tc, Td (FIG. 5, middle diagram).

The activation intervals T2a, T2b, T2c, T2d are dimensioned such that the amplifier 12 is activated when the receivers 6 receive light beams 3 in the form of light impulses L1, L2, L3, L4 from the associated transmitters 4 (FIG. 5, lower diagram).

Since the amplifier 12 is deactivated during the switching processes of the receivers 6, no interference caused by the switching processes is transmitted to the amplifier 12.

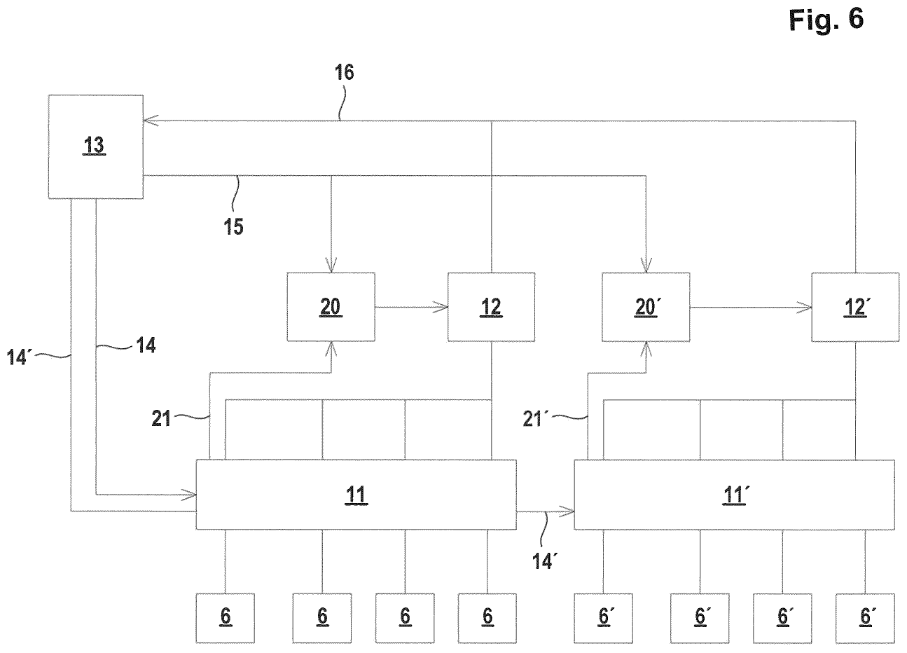

FIG. 6 shows a further receiving-side switching arrangement for the light curtain 1 according to FIG. 1.

In this case, two cascades are provided with receivers 6, 6′. In a first cascade, receivers 6 are run to a first multiplexer 11 with a first amplifier 12. A first amplifier addressing unit 20 is associated with the first amplifier 12, which addressing unit 20 is controlled by the cascade control 13 via the control line 15.

The first multiplexer 11 actuates the first amplifier addressing unit 20 via a control line 21.

Accordingly, in a second cascade, receivers 6′ are run to a second multiplexer 11′ with a second amplifier 12′. A second amplifier addressing unit 20′ controlled by the cascade control 13 via the control line 15 is associated with the second amplifier 12′.

The second multiplexer 11′ actuates the second amplifier addressing unit 20′ via a control line 21′.

The cascade control 13 controls the operation of both cascades via the control lines 14, 14′, which are run to the multiplexers 11, 11′, and via the control line 15, which is run to the amplifier addressing unit 20, 20′.

A selection of the receivers 6, 6′ to be activated takes place via the control lines 14, 14′, the activation of the amplifiers 12, 12′ is controlled via the control line 15. The selection of the amplifiers 12, 12′ takes place via the control lines 21, 21′. A testing of the amplifier 12, 12′ can also take place via these control lines 21, 21′.

The receipt signals amplified in the amplifiers 12, 12′ are supplied via the line 16 to the cascade control 13 and then to the evaluation unit 8.

Otherwise, the functioning of the switching arrangement according to FIG. 6 corresponds to the embodiment according to FIG. 3, wherein the time diagrams according to FIG. 4, in particular, are valid as well.

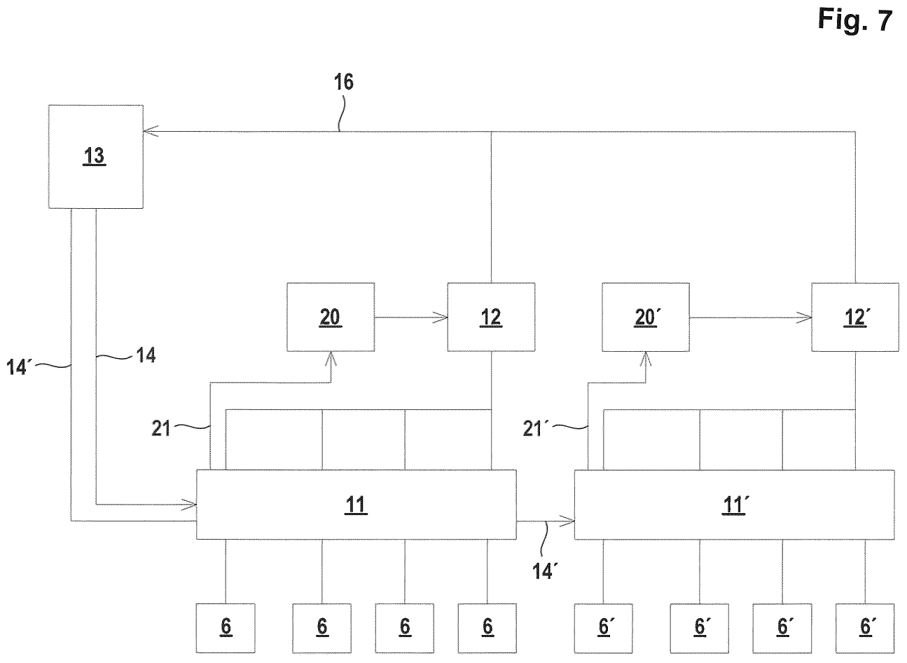

FIG. 7 shows a variant of the embodiment according to FIG. 6. The embodiment according to FIG. 7 differs from the embodiment according to FIG. 6 only in that no control line 15 is run to the amplifier addressing units 20, 20′ from the cascade control 13. Consequently, the multiplexers 11, 11′ perform the complete actuation of the amplifier addressing units 20, 20′ via the control lines 21, 21′.

### LIST OF REFERENCE NUMERALS

(1) light curtain
(2) transmitter unit
(3) light beam
(4) transmitter
(5) receiver unit
(6, 6′) receiver
(7) control unit
(8) evaluation unit
(9a, b) transmitter-receiver unit
(10a, b) control and evaluation unit
(11, 11′) multiplexer
(12, 12′) amplifier
(13) cascade control
(14, 14′) control line
(15) control line
(16) line
(17, 17′) line
(18a, b) CPU
(19a, b) output
(20, 20′) amplifier addressing unit
(21, 21′) control line

1. A light curtain (1) for capturing objects in a monitoring region with an arrangement of transmitters (4) emitting light beams (3), with an arrangement of receivers (6, 6′) receiving light beams (3), and with an evaluation unit (8) in which, in dependence on receipt signals from the receivers (6, 6′), an object identification signal is generated, characterized in that the receivers (6, 6′) constitute at least one cascade, and that the receivers (6, 6′) are individually switched-into an amplifier (12, 12′) sequentially by means of a multiplexer (11, 11′), wherein the amplifier (12, 12′) is deactivated during an activation of a switching-in of a receiver (6).

2. The light curtain (1) according to claim 1, characterized in that the amplifier (12, 12′) is deactivated during a deactivation of a switching-in of a receiver (6).

3. The light curtain (1) according to claim 1, characterized in that a plurality of cascades of receivers (6, 6′) are present, wherein the receivers (6, 6′) of each cascade are switched into an amplifier (12, 12′) by means of a multiplexer (11, 11′).

4. The light curtain (1) according to claim 1, characterized in that a cascade control (13) is present, by means of which the or all multiplexers (11, 11′) are controlled.

5. The light curtain (1) according to claim 4, characterized in that the cascade control (13) is part of a computer assembly that contains the evaluation unit (8), wherein the computer assembly as an evaluation unit (8) has a CPU or two CPUs (18a, 18b) which mutually monitor each other.

6. The light curtain according to claim 1, characterized in that each multiplexer (11, 11′) has a shift chain or an addressing unit.

7. The light curtain (1) according to claim 6, characterized in that the activation and deactivation of receivers (6, 6′) and/or amplifiers (12, 12′) is derived from their shift chain or the addressing unit.

8. The light curtain (1) according to claim 4, characterized in that the activation and deactivation of receivers (6, 6′) and/or amplifiers (12, 12′) is performed by means of the cascade control (13).

9. The light curtain (1) according to claim 6, characterized in that display means are activated by means of the shift chain or by means of the addressing unit, and/or that the associated amplifier (12, 12′) is tested by means of the shift chain or by means of the addressing unit.

10. The light curtain (1) according to claim 9, characterized in that test pulses are generated for testing in the shift chain or in the addressing unit, supplied to the amplifier (12, 12′) and read back by the latter, wherein read-back test pulses are compared with an expected result in the shift chain or in the addressing unit.

11. The light curtain (1) according to claim 3, characterized in that an amplifier addressing unit (20, 20′) actuated by the associated multiplexer is associated with each amplifier (12, 12′).

12. The light curtain (1) according to claim 11, characterized in that the multiplexer (11, 11′) actuates the amplifier addressing unit (20, 20′) for selecting an amplifier (12, 12′) and/or for testing an amplifier (12,12′).

13. The light curtain (1) according to claim 4, characterized in that each amplifier addressing unit (20, 20′) is actuated to activate or deactivate the associated amplifier (12, 12′) by the cascade control (13).

14. The light curtain (1) according to claim 1, characterized in that the object identification signal is a binary switching signal, the switching states of which indicate whether an object is present in the monitoring region or not, or characterized in that the object identification signal contains a geometric characteristic value of a captured object.

15. The light curtain (1) according to claim 1, characterized in that it has two housings arranged at opposite edges of the monitoring region, in which housings respectively sensor components are present, wherein in a first housing a series arrangement of transmitters (4) is present as sensor components and in the second housing a series arrangement of receivers (6, 6′) is present, or characterized in that both in the first as well as in the second housing, transmitters (4) and receivers (6, 6′) are present as sensor components, wherein an alternating series arrangement of transmitters (4) and receivers (6, 6′) is present in each housing.
